(19) United States
(12) Patent Application Publication
(10) Pub. No.: US 2014/0050914 A1
(43) Pub. Date: Feb. 20, 2014

(54) ANTIREFLECTIVE COATINGS WITH CONTROLLABLE POROSITY AND REFRACTIVE INDEX PROPERTIES USING A COMBINATION OF THERMAL OR CHEMICAL TREATMENTS

(71) Applicants: Nikhil D. Kalyankar, Hayward, CA (US); Scott A. Jewhurst, Redwood City, CA (US)

(72) Inventors: Nikhil D. Kalyankar, Hayward, CA (US); Scott A. Jewhurst, Redwood City, CA (US)

(73) Assignee: Intermolecular, Inc., San Jose, CA (US)

(21) Appl. No.: 13/584,918

(22) Filed: Aug. 14, 2012

(51) Int. Cl. B32B 5/18; B05D 5/00

(52) U.S. Cl. 428/317.9; 427/243

(57) ABSTRACT

In some embodiments, the current invention discloses methods and apparatuses for making coated articles including a two step treatment process of a coated layer. The first step of the heat treatment involves a thermally assisted curing of the coated layer at a low temperature, which can strengthen the bond formation in the coated layer, leading to better layer stability during the subsequent heat treatment. The second step of the heat treatment involves annealing of the cured layer at a high temperature, which can control a porosity of the coated layer.

### FIELD OF THE INVENTION

Embodiments of the invention relate generally to methods and apparatuses for forming antireflection layers on substrates.

### BACKGROUND OF THE INVENTION

Coatings that provide low reflectivity or a high percent transmission over a broad wavelength range of light are desirable in many applications including semiconductor device manufacturing, solar cell manufacturing, glass manufacturing, and energy cell manufacturing. The refractive index of a material is a measure of the speed of light in the material which is generally expressed as a ratio of the speed of light in vacuum relative to that in the material. Low reflectivity coatings generally have a refractive index (n) in between air (n=1) and glass (n˜1.5).

An antireflective (AR) coating is a type of low reflectivity coating applied to the surface of a transparent article to reduce reflectivity of visible light from the article and enhance the transmission of such light into or through the article. One method for decreasing the refractive index and enhancing the transmission of light through an AR coating is to increase the porosity of the antireflective coating. Porosity is a measure of the void spaces in a material. Although such antireflective coatings have been generally effective in providing reduced reflectivity over the visible spectrum, the coatings have suffered from deficiencies when used in certain applications. For example, porous AR coatings which are used in solar applications are highly susceptible to moisture absorption. Moisture absorption may lead to an increase in the refractive index of the AR coating and corresponding reduction in light transmission.

Thus, there is a need for AR coatings which exhibit increased transmission, reliability and durability.

### SUMMARY OF THE DISCLOSURE

In some embodiments, the current invention discloses methods and apparatuses for making coated articles including a pretreatment process of a coated layer, followed by a heat treatment process. The pretreatment process can involve a preheating step, including a thermal treatment at a low temperature, or a chemical treatment of the coated layer. The pretreatment can strengthen the bond formation in the coated layer, leading to better layer stability during the subsequent heat treatment. The heat treatment can involve annealing of the cured layer at a high temperature, which can control a porosity of the coated layer.

In some embodiments, the coated layer can be deposited using a sol-gel process. For example, a gel using various particles containing sol formulations and/or various binders can be coated on a substrate to form the coated layer. For example, a silica sol, where silica sol is a solution having silicate polymers or silica nanoparticles smaller than 100 nm, can be used as a precursor to deposit the coated layer. As an example, alkylalkoxysilane or bis(alkoxysilylalkane) based sol-gel formulations can be coated on a glass substrate to form anti-reflective coatings with controlled porosity and durability.

In some embodiments, the pretreatment process can accelerate a reaction in the coated layer, increasing the strength of the network of molecules in the coated layer. For example, the coated layer can include silicon and oxygen, e.g., an alkylalkoxysilane or bis(alkylalkoxysilane) based sol-gel formulation, and the pretreatment process can enhance a formation of the Si—O—Si network by accelerating the silanol (Si—OH) condensation reaction. In some embodiments, the pretreatment can control the porosity and the refractive index in the coated layer, resulting in an antireflective layer suitable for effective light transmission.

In some embodiments, the heat treatment can be performed in less than or equal to about 30 minutes. The temperature of the heat treatment can be less than or equal to about 750 C, and can be greater than or equal to about 300 C.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the current invention can readily be understood by considering the following detailed description in conjunction with the accompanying drawings, in which:

FIGS. 1A-1B illustrate a porous coating according to some embodiments of the current invention.

FIGS. 2A-2B illustrate silica based nanoparticles bonded through —Si—O—Si— bonds according to some embodiments of the current invention.

FIG. 3A-3B illustrate a potential effect of the pretreatment on silica particles according to some embodiments of the current invention.

FIG. 4A-4B illustrate another potential effect of the pretreatment on silica particles according to some embodiments of the current invention.

FIG. 5 illustrates a flowchart to process a coating according to some embodiments of the current invention.

FIG. 6 illustrates another flowchart to process a coating according to some embodiments of the current invention.

FIG. 7 discloses another method to form a porous layer including silica-based particles according to some embodiments of the current invention.

### DETAILED DESCRIPTION OF THE PREFERRED EMBODIMENTS

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, the current invention relates to methods, and coated articles fabricated from the methods, for strengthening the bonding between inorganic materials in a mixture of organic and inorganic components before removing organic components to form a porous layer of inorganic components.

In some embodiments, the current invention discloses methods, and coated articles fabricated from the methods, including subjecting a coated layer to a first pretreatment process before subjecting the coated layer to a second heat treatment involving annealing at high temperatures, for example, to control a porosity property of the coated layer. In general, the second heat treatment includes a combustion process, burning the organic components in the coated layer to form pores.

In some embodiments, the current invention discloses methods, and coated articles fabricated from the methods, including treating an alkylalkoxysilane or bis(alkylalkoxysilane) based sol-gel formulation to a first pretreatment process for strengthening the bond formation of the particle network before subjecting the formulation to a second heat treatment involving annealing at high temperature. For example, the sol-gel formulation can include silica particles, and a first pretreatment can enhance the formation of Si—O—Si network by accelerating the silanol (Si—OH) condensation reaction. The increase in Si—O—Si bond formation can lead to a stronger Si—O—Si network, e.g., stronger coupling between silica particles, and a coated layer that is less prone to thermal relaxation during the second heat treatment.

The first pretreatment can include a thermal treatment. The thermal treatment can be performed at a temperature lower than the temperature of the second heat treatment or at a shorter time than the time of the second heat treatment. The pretreatment can include a chemical treatment. While a focus of the second heat treatment is to control the porosity, for example, by removing the organic components, the pretreatment can be directed to accelerate silanol condensation reactions, converting individual silanol groups Si—OH to interlinked Si—O—Si network, which can strengthen the bonds between silica particles. A typical reaction can be

Si—OH+Si—OH→Si—O—Si+H₂O (1)

The condensation reaction can be accelerated by thermal energy or by a chemical catalyst. For example, ammonia (or any other alkaline vapor) can react with silanol to form ammonium hydroxide as followed:

Si—OH+Si—OH+NH₃→Si—O—Si+NH₄OH (2)

In some embodiments, the current invention discloses a wet chemical film deposition process using a sol-formulation including alkylalkoxysilane-based binder to produce porous anti-reflective coatings with a low refractive index (e.g., lower than glass). The sol-formulation can include silica based nanoparticles, titania based nanoparticles, or other nanoparticles.

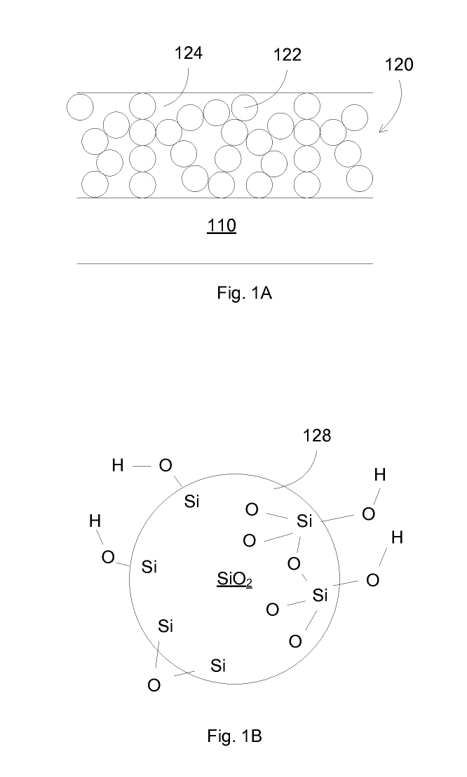

FIGS. 1A-1B illustrate a porous coating according to some embodiments of the current invention. In FIG. 1A, a porous layer 120 is disposed on a substrate 110. The porous layer 120 can include particles 122 disposed in a network 124. The particles can be silica (SiO₂) particles, titania (TiO₂) particles, or particles having other compositions of typically inorganic oxides. The particles are shown as spherical particles, but can be any shapes and sizes, such as elliptical particles or disk-shaped particles. The network can include a binder to connect the particles 122. FIG. 1B shows a silica-based particle, e.g., SiO₂, 128. The surface of the silica particles can include silanol (—Si—OH) or siloxane (—Si—O—Si—) or other special functionalities e.g. thiol (—SH), amine (—NH₃), carboxyl (—COOH) etc.

In some embodiments, the porous coating can be formed by a sol-gel technique. The porous coating can be formed by a two step curing process, including a first pretreatment step to enhance the bonding between the particles, as well as strengthen the —Si—O—Si— network in the binder molecules, and a second heat treatment to form the porous layer, e.g., remove organic content in the coated layer.

In general, a sol-gel process is a process where a wet formulation (commonly called the sol or sol-formulation) is dried to form a gel coating (e.g., gel-formulation) having both liquid and solid characteristics. The gel coating is then heat treated to form a solid material. The gel coating or the solid material may be formed by applying a thermal treatment to the sol. This technique is widely used for antireflective coatings because it is easy to implement and provides films of uniform composition and thickness.

The porous coating can be a porous silicon oxide (SiO₂) coating or a porous titanium oxide (TiO₂) coating or a coating of an inorganic oxide capable of bonding with the substrate. A sol formulation is coated on the substrate. The substrates can include glass, silicon, metallic coated materials, or plastics. The substrate may be a transparent substrate. The substrate could be optically flat, textured, or patterned. The substrate may be flat, curved or any other shape as necessary for the application under consideration. The glass substrates can include high transmission low iron glass, borosilicate glass (BSG), soda lime glass and standard clear glass. The sol-gel composition may be coated on the substrate using, for example, dip-coating, spin coating, curtain coating, roll coating, capillary coating, or a spray coating process. Other application methods known to those skilled in the art may also be used. The substrate may be coated on a single side or on multiple sides.

The sol formulation is dried to form a gel coating. A gel is a coating that has both liquid and solid characteristics and may exhibit an organized material structure. A gel can be described as a diffuse crosslinked solid matrix, containing a dispersed liquid. The crosslinking can span any range of bonding from Van der Waals to covalent to ionic. Gels don't really exhibit liquid characteristics, since they do not flow, a key defining feature of liquids. During the drying, the solvent of the sol-gel composition is evaporated and further bonds between the components, or precursor molecules, may be formed. The drying may be performed by exposing the coating on the substrate to the atmosphere at room temperature. The coatings (and/or the substrates) may alternatively be exposed to an elevated temperature above the boiling point of the solvent. The drying of the coatings may not require elevated temperatures, but may vary depending on the formulation of the sol-gel compositions used to form the coatings. In some embodiments, the drying temperature may be in the range of approximately 25 degrees Celsius to approximately 200 degrees Celsius. In some embodiments, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used during sol formation.

The gel coating can be fully cured, e.g., heat treated to a final temperature, to form a porous coating. The temperature and time of the heat treatment may be selected based on the chemical composition of the sol-gel compositions, depending on what temperatures may be required to form crosslinking between the components throughout the coating. In some embodiments, the temperature may be in the range of 500 degrees Celsius and 1,000 degrees Celsius. In some embodiments, the temperature may be 600 degrees Celsius or greater. In some embodiments, the temperature may be between 625 degrees Celsius and 650 degrees Celsius. The heat treatment process may be performed for a time period of between about 3 minutes and 1 hour, for example, about 6 minutes.

The single porous coating may have a thickness between about 5 nanometers and about 1,000 nanometers.

In some embodiments, a sol formulation having a binder and nanoparticles can be used. In some embodiments, the binder includes a silicon-based binder, such as a silane-based binder. The nanoparticles can include silicon-based nanoparticles, such as silica or siloxane-based nanoparticles. A binder can include a component used to bind together, e.g., by adhesion and cohesion, one or more types of materials in mixtures. The binder can include inorganic and organic components, for example, an alkylalkoxysilane-based binder or a tetraalkoxysilane binder.

In some embodiments, the sol-formulation may be prepared by mixing an alkylalkoxysilane-based binder (including bis(alkylalkoxysilane)-based binder), nanoparticles such as silica or titania based nanoparticles, an acid or base containing catalyst, water, and a solvent system. The sol-formulation may be formed by hydrolysis and/or polycondensation reactions. The sol-formulation may be stirred at room temperature or at an elevated temperature (e.g., 50-60 degrees Celsius) until the sol-formulation is substantially in equilibrium (e.g., for a period of 24 hours). The sol-formulation may then be cooled and additional solvents added to either reduce or increase the ash content if desired.

Details of sol formulations having a binder and nanoparticles can be found in co-owned, co-pending applications, application Ser. No. 13/195,119 with filing date of Aug. 1, 2011, entitled “Sol-gel based antireflective coatings using particle-binder approach with high durability, moisture resistance, closed pore structure and controllable pore size”; application Ser. No. 13/195,151 with filing date of Aug. 1, 2011, entitled “Antireflective silica coatings based on sol-gel technique with controllable pore size, density, and distribution by manipulation of inter-particle interactions using pre-functionalized particles and additives”, and application Ser. No. 13/273,007 with filing date of Oct. 13, 2011, entitled “Sol-gel based antireflective coatings using alkyltrialkoxysilane binders having low refractive index and high durability”, all of which are hereby incorporated by reference for all purposes.

The alkylalkoxysilane-based binder may be represented by the general formula R′ₙ—Si—(OR)₄₋ₙ, n=0-4, wherein R′ and R are the same or different and each represents an alkyl group containing 1 to 20 carbon atoms, an aryl group containing 6 to 20 carbon atoms, or an aralkyl group containing 7 to 20 carbon atoms, or a fluoro-modified alkyl group containing 1 to 20 carbon atoms. The amount of the alkylalkoxysilane-based binder in the sol-formulation may be present in the sol-formulation in an amount between about 0.1 wt. % and about 50 wt. % of the total weight of the sol-formulation. In some embodiments, the alkylalkoxysilane-based binder may be used with other binders, such as orthosilicate-based binders, for example, tetraethylorthosilicate (TEOS).

The silica based nanoparticles may be spherical or non-spherical (e.g., elongated, pearl-shaped, or disc-shaped). The silica based nanoparticles include silica based nanoparticles with at least one dimension between 10 and 200 nanometers. The silica based nanoparticles may be colloidal silica mono-dispersed in an organic solvent. The silica nanoparticles could also be a mixture of particles of different shapes and sizes.

The amount of silica based nanoparticles in the sol-formulation may include between about 0.01 wt % to about 15 wt % of the total weight of the sol-formulation. A mass ratio of the alkylalkoxysilane-based binder to silica based nanoparticles may be between 60:40 and 90:10. The sol-formulation can further include other oxide nanoparticles, such as rare-earth-based oxide nanoparticles.

After drying to form the gel coating, a heat treatment process can be used to burn off the organic components of the binder. The inorganic materials remaining after combustion of the organic matter for a sol-formulation can include silica from the nanoparticles and silica from the binder. In general, an increase of the binder in a sol formulation would lead to a reduction in pore fraction and a corresponding increase in the refractive index of the resulting anti-reflective coating. The amount of inorganic components remaining after combustion of the organic matter in the sol formulation is called the ash content of the sol formulation.

The silica binder ash content can affect the refractive index of an anti-reflective coating. Thus sol formulations with different binder or nanoparticles ratios can provide a coated layer with different index of refraction. For example, higher percentage of silica binder ash content can increase the silica contribution from the binders, as compared to the silica contribution from the silica particles, leading to higher index of refraction.

In some embodiments, the porous coating can be formed by a heat treatment process where a chemical compound in the sol formulation can burn off upon combustion to form a void space or pore of a desired size and shape. The size and interconnectivity of the pores may be controlled, for example, through the sol-formulation, polarity of the molecule and solvent, and other physiochemical properties of the gel phase, in addition to the parameters of the heat treatment process.

In some embodiments, the sol-gel system further includes a film forming precursor which forms the primary structure of the gel and the resulting solid coating. The film forming precursors can include silicon containing precursors and titanium based precursors. The sol-gel system may further include alcohol and water as the solvent system, and either an inorganic or organic acid or base as a catalyst or accelerator. A combination of the aforementioned chemicals leads to formation of sol through hydrolysis and condensation reactions. Various coating techniques, including dip-coating, spin coating, spray coating, roll coating, capillary coating, and curtain coating as examples, may be used to coat thin films of these sols onto a solid substrate (e.g., glass). During the coating process, a substantial amount of solvent evaporates leading to a sol-gel transition with formation of a wet film (e.g., a gel). Around or during the sol-gel transition, the porosity forming agent can form nanostructures. The deposited wet thin films containing micelles or porogen nanostructures may then be heat treated to remove excess solvent and annealed at an elevated temperature to create a polymerized —Si—O—Si— or —Ti—O—Ti— network and remove all excess solvent and reaction products formed by oxidation of the porosity forming agent, thus leaving behind a porous film with a low refractive index, where n is less than 1.3, to ultra low refractive index where n is less than 1.2.

In some embodiments, a sol formulation can include other components, for example, to form a reaction mixture by a hydrolysis or polycondensation reaction. The mixture can be designed to form multilayer coatings with different porosity, resulting in multiple layers or an integrated layer having gradual changing in index of refraction.

In some embodiments, the sol-gel composition can further include an acid or base catalyst for controlling the rates of hydrolysis and condensation. The acid or base catalyst may be an inorganic acid, organic acid, or base catalyst. The acid catalysts may include hydrochloric acid (HCl), nitric acid (HNO₃), sulfuric acid (H₂SO₄), acetic acid (CH₃COOH), and combinations thereof. The base catalysts include tetramethylammonium hydroxide (TMAH), sodium hydroxide (NaOH), potassium hydroxide (KOH), and the like.

The sol-gel composition can further include a solvent system. The solvent system may include a non-polar solvent, a polar aprotic solvent, a polar protic solvent, and combinations thereof. Selection of the solvent system and the self assembling molecular porogen may be used to influence the formation and size of micelles. The solvents include alcohols, for example, n-butanol, isopropanol, n-propanol, ethanol, methanol, and other well known alcohols. The solvent system may further include water. The amount of solvent may be from 35 to 99.9 wt. % of the total weight of the sol-gel composition.

The solvent system may further include water. Water may be present in 0.5 to 10 times the stoichiometric amount needed to hydrolyze the silicon containing precursor molecules. Water may be present from 0.001 to 0.1 wt. % of the total weight of the sol-gel composition.

The sol-gel composition may further include a surfactant. In some embodiments, the surfactant may be used for stabilizing the sol-gel composition. The surfactant can include an organic compound that lowers the surface tension of a liquid and contains both hydrophobic groups and hydrophilic groups. Thus the surfactant contains both a water insoluble component and a water soluble component. The surfactant may also be used to stabilize colloidal sols to reduce the precipitation of solids over extended periods of storage. In some embodiments, the surfactant may be used as a porogen which forms molecular aggregates (miscelles) before or during the sol-gel transition step at the time of coating application.

The sol-formulation may further include a gelling agent or solidifier. The solidifier may be used to expedite the transition of a sol to a gel. It is believed that the solidifier increases the viscosity of the sol to form a gel. The solidifier may include: gelatin, polymers, silica gel, emulsifiers, organometallic complexes, charge neutralizers, cellulose derivatives, and combinations thereof.

In some embodiments, the alkylalkoxysilane-based binder can be represented by the general formula of R′ₙ—Si—(OR)₄₋ₙ, where R and R′ can be the same or different and each represents a carbon chain. For example, an alkylt rialkoxysilane-based binder may be represented by the general formula shown below:

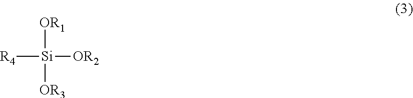

R₁, R₂, R₃, and R₄ can be the same or different and each represents an alkyl group, for example, n-butyl, isobutyl, n-pentyl, isopentyl, n-hexyl, isohexyl, cyclohexyl, n-heptyl, methoylcyclohexyl, octyl, or ethylcyclohexyl.

The alkyltrialkoxysilane-based binders may include n-propyltriethoxysilane, n-pentyltriethoxysilane, n-hexyltriethoxysilane, cyclohexyltrimethoxysilane, 3-(heptafluoroisopropoxy)propyltrimethoxysilane, Octyltrimethoxysilane, 1,2-Ethylenebis(trimethoxysilane), 1,6-Bis(trimethoxysilyl)hexane, Cyclooctyltrimethoxysilane, (Cyclopentenyloxy)trimethylsilane, N-cyclohexylaminopropyltrimethoxysilane, N-octadecyltrimethoxysilane, Dodecyltrimethoxysilane, Isooctyltrimethoxysilane, 3-chloropropyltrimethoxysilane, Acetoxymethyltrimethoxysilane, 3-cyanopropyltrimethoxysilane, (Bucycloheptenyl)ethyl]trimethoxysilane, 3-isocyanotopropyltrimethoxysilane, 3-Mercaptopropylmethyldimethoxysilane, 3-aminopropyltriethoxysilane Allyltrimethoxysilane, 2-Ferrocenylethyltriethoxysilane, methyltriethoxysilane (MTES), methyltrimethoxysilane (MTMS), glycidoxipropyltrimethoxysilane (Glymo), N-butyltrimethoxysilane, aminoethyltrimethoxysilane, trimethoxysilane, triethoxysilane, vinyltrimethoxysilane, propyltriethoxysilane (PTES), ethyltriethoxysilane (ETES), n-butyltriethoxysilane (BTES), methylpropoxysilane, and combinations thereof.

In some embodiments, the bis(alkylalkoxysilane)-based binder can be represented by the general formula of (R′ₙ(OR)₃₋ₙSi)₂R″, where R, R′ and R″ can be the same or different and each represents a carbon chain. For example, a bis(alkyltrialkoxysilane)-based binder may be represented by the general formula shown below:

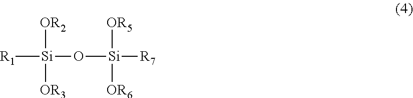

In some embodiments, the alkylalkoxysilane-based binder may be used with other binders. Other binders that may be used with the alkyltrialkoxysilane-based binders described herein include orthosilicate-based binders. The orthosilicate-based binders may include tetraethylorthosilicate (TEOS), tetramethylorthosilicate, (TMOS), tetrapropylorthosilicate, tetrabutylorthosilicate, tetrakis(trimethylsilyloxy)silane, tetrapropylorthosilicate (TPOS), propyltriethylorthosilicate (PTES), and combinations thereof.

A sol-formulation can be prepared using an alkylalkoxysilane based binder with a hydrolysis and/or a condensation reaction. For example, a hydrolysis reaction for a alkyltrimethoxy silane binder can be

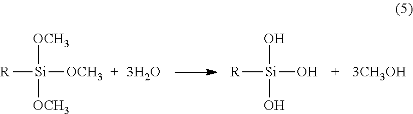

A condensation reaction for the binder can be, which can form a chain of —Si—O—Si— is

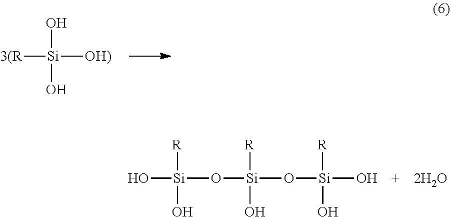

The condensation reaction can also occur between particles that have OH groups passivating the surface. For example, silica based particles, which have surfaces terminated with OH groups, e.g., —Si—OH terminating surface, can be bonded together through a condensation reaction

2(—Si—OH)→—Si—O—Si—+H₂O (7)

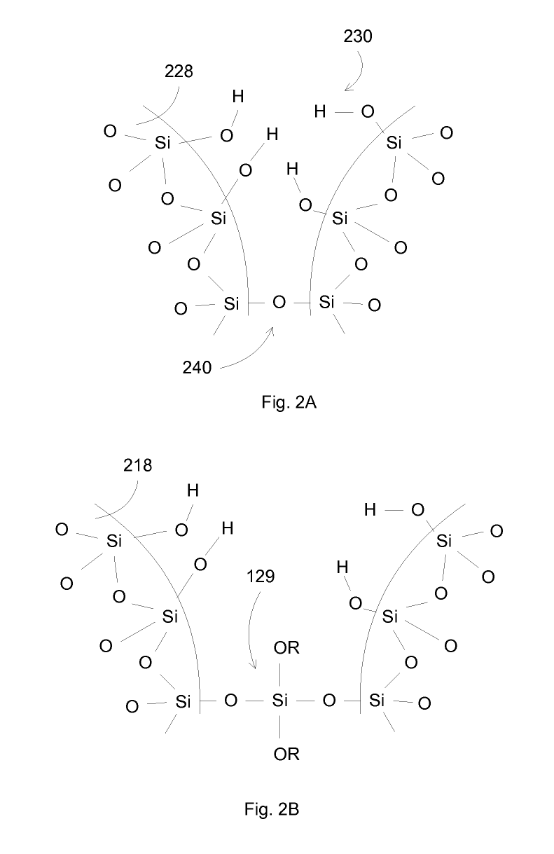

FIGS. 2A-2B illustrate silica based nanoparticles bonded through —Si—O—Si— bonds according to some embodiments of the current invention. In FIG. 2A, silica particles 228 can include SiO₂, having silicon atoms bonded to oxygen atoms. The surface can be covered with OH terminating groups 230, bonded to silicon at the surface. During the sol-gel process, condensation reactions can couple the silica particles 228, for example, through the Si—O—Si bond 240. FIG. 2B shows a silica particles 218, bonded through a binder 129. The binder 129 can be an organosilicate monomer (e.g., R′ₙ—Si—(OR)₄₋ₙ, n=0-2), oligomeric organosilicate, or a bis-silane (e.g. (R′ₙ(OR)₃₋ₙ,Si)₂R″, n=0-1).

In some embodiments, the current invention discloses methods, and coated articles utilizing the methods, including first a pretreatment process to strengthen the bonds between the particles, followed by a heat treatment to form the porous layer. In some embodiments, the coated layer can include a gel coating, prepared from a sol formulation having alkylalkoxysilane based binder, including bis(alkylalkoxysilane) based binder, and a particle network, such as silica based or titania based nanoparticles.

In some embodiments, the pretreatment can accelerate a reaction in the coated layer, increasing the strength of the network of molecules in the coated layer. For example, the pretreatment can enhance a formation of the Si—O—Si network by accelerating the silanol (Si—OH) condensation reaction.

In some embodiments, the coated layer includes a solid porous silica layer, which can be deposited using a liquid precursor and then dried or cured. The precursor can include small particles in a solvent mixture, for example, including nano sized particles, silica-based particles or silica-based nanoparticles. The precursor can be prepared using a polymeric silica sol in a solvent. The silica polymer can include an organosilicate monomer (e.g., R′ₙ—Si—(OR)₄₋ₙ, n=0-2), oligomeric organosilicate, or a bis-silane (e.g. (R′ₙ(OR)₃₋ₙ,Si)₂R″, n=0-1).

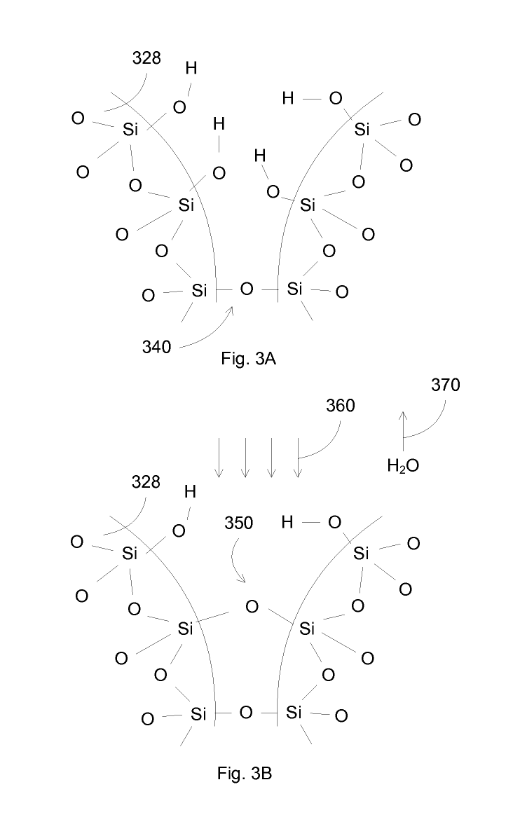

FIG. 3A-3B illustrate a potential effect of the pretreatment on silica particles according to some embodiments of the current invention. In FIG. 3A, adjacent silica-based particles 328, e.g., particles including SiO₂, are bonded through oxygen atoms 340 to surface silicon atoms. Other surface silicon can accept absorbed water, and can be bonded to OH molecules. In FIG. 3B, the silica-based particles are exposed to a pretreatment process 360, for example, by a thermal treatment or by a chemical treatment, e.g., an exposure in ammonia vapor. Condensation bonding can occur between nearby —Si—OH groups, forming —Si—O—Si— bonding 350, and releasing H₂O 370. The condensation bonding can strengthen the linkage between particles through the additional bonding of surface silicon.

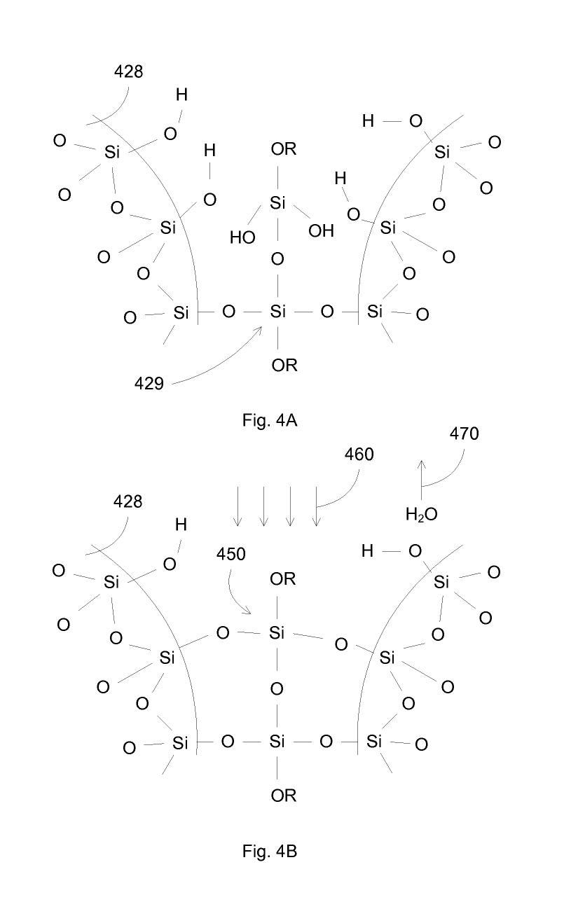

FIG. 4A-4B illustrate another potential effect of the pretreatment on silica particles according to some embodiments of the current invention. In FIG. 4A, adjacent silica-based particles 428, e.g., particles including SiO₂, are bonded through partially hydrolyzed silicon alkoxide or alkoxysilane binder 429. Other surface silicon can accept absorbed water, and can be bonded to OH molecules. In FIG. 4B, the silica-based particles are exposed to a pretreatment process 460, for example, by a thermal treatment or by a chemical treatment, e.g., with ammonia vapor. Condensation bonding can occur between —Si—OH groups and the —Si—OH in the binder, forming additional —Si—O—Si— bonding 450, and releasing H₂O 470. The condensation bonding can strengthen the linkage between particles through the additional bonding of surface silicon.

In some embodiments, the pretreatment can include a thermal treatment. For example, the thermal treatment can enhance the condensation reaction, forming Si—O—Si bonds between the silica based particles.

In some embodiments, the thermal treatment can be performed between about 1 second and less than or equal to about 10 minutes, or between about 1 second and less than or equal to about 5 minutes. The temperature of the thermal treatment can be between 100 C and less than or equal to about 400 C, and can be between 100 C and less than or equal to about 300 C.

In some embodiments, the pre treatment can include a chemical treatment process, for example, by exposing to a chemical ambient environment. For example, the chemical treatment of the coated layer can be performed in a controlled ambient containing a curing and/or mineralizing agent such as ammonia. The ambient can also include a hydroxyl-containing vapor, such as water or alcohol. In some embodiments, the alkaline vapor includes vapor of a basic material, e.g., a compound that can accept a proton (such as a hydrogen ion H⁺). For example, the base material can be ammonia or other alkaline vapors (amines, hydroxylamines, quarternary ammonium hydroxides). The alkaline ambient can control the reaction rates, the condensation reactions, and can enhance the silicon network. For example, varying chemical curing conditions in the wet coated layer may enhance the diffusion and chemical reactions, leading to a stronger Si—O—Si network, resulting in a coated layer which is less prone to thermal relaxation during a subsequent high temperature process.

In some embodiments, the chemical treatment in an alkaline ambient can be performed at any temperature, and preferably at room temperature. The treatment can be performed in less than or equal to about 1000 minutes, and preferably less than or equal to about 100 minutes. Higher temperatures can be used, preferably in a closed environment to retain the vapor, for example, at less than or equal to about 200 C.

In some embodiments, the coated layer, after being chemically treated with an alkaline vapor, is further subjected to an optional heat treatment, for example, to dry the coating or to sinter the coated layer. In some embodiments, after exposing the coated layer to an alkaline vapor for some duration, the substrate is removed from the alkaline vapor ambient. Evaporation of the absorbed alkaline vapor on the coated layer can be performed, either at room temperature or at an elevated temperature (e.g., at less than about 300 C). An optional heat treatment of the modified coated layer can be performed to dehydrate the layer or to allow viscous sintering.

In some embodiments, the pretreatment process, either by a thermal treatment or by a chemical exposure, can generate a reaction in the coated layer, for example, to increase coating adhesive and cohesive strength, as well as allowing modification of the refractive index and spectral response of the coatings through film porosity modification, which can enhance mechanical and optical property.

In some embodiments, after the pretreatment, the coated layer can be subjected to a high temperature heat treatment, for example, to control the porosity and the refractive index in the coated layer. In some embodiments, the high temperature heat treatment can be performed between about 1 second and less than or equal to about 30 minutes. The temperature of the high temperature heat treatment can be less than or equal to about 750 C, and can be greater than or equal to about 300 C.

In some embodiments, the current invention discloses coated articles including a multiple step treatment of an antireflective layer to control the porosity and/or refractive index. The coated article can include other layers such as a base layer, a seed layer, an infrared reflective layer, a barrier layer and a protective layer.

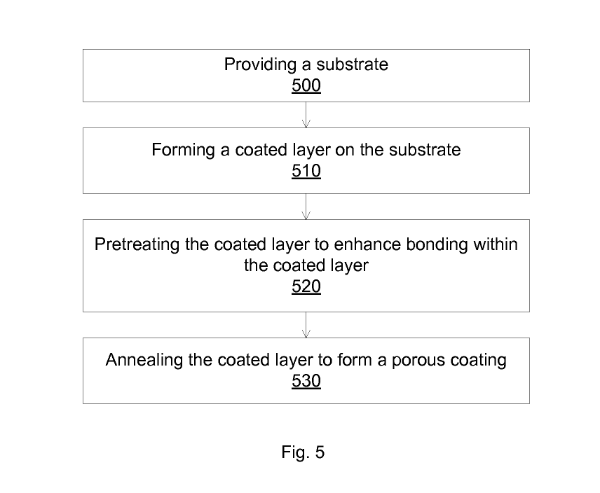

FIG. 5 illustrates a flowchart to process a coating according to some embodiments of the current invention, disclosing a pretreatment process of a deposited layer to enhance the bonding within the layer before heat treating the layer for forming pores. The enhanced bonding can provide a porous film that is less prone to thermal relaxation during the heat treatment.

In operation 500, a substrate is provided. The substrate can be a transparent substrate, such as a glass substrate or a polymer substrate. In operation 510, a coated layer is formed on the substrate. The coated layer can be deposited by dip-coating, spin coating, curtain coating, roll coating, capillary coating, or a spray coating process. In operation 520, the coated layer is pretreated to enhance the bonding within the coated layer. For example, the pretreatment can include an enhancement of a condensation reaction, such as a thermal treatment or a chemical treatment. The condensation reaction can convert individual Si—OH groups to interlinked Si—O—Si bonds, strengthening the linkage in the coated layer. In operation 530, the coated layer, after the pretreatment, is subjected to a heat treatment process to form pores, for example, by combusting organic matter within the coated layer, and leaving the inorganic components.

The porous layer includes a material distributed as to include empty spaces, e.g., pores, throughout the porous layer. The porous layer can include closed pore structures, meaning the pores are distributed in a network without being connected to each other. The porous layer can include open pore structures, meaning the pores are distributed in a network and connected to each other. The porous layer can include a combination of closed pore structures and open pore structures. The porous layer can include a plurality of pores distributed in the layer. The porous layer can include a plurality of particles distributed in the layer, wherein the space between the particles forms the pore structure.

In some embodiments, the current invention discloses methods for forming a porous layer having improved antireflective property, such as tuning the refractive index or control the porosity. The methods include exposing a coated layer to a pretreatment before a high temperature heat treatment process for forming the porous layer. For example, the coated layer can be formed by a sol-gel process, coating the substrate with a sol formulation including alkylalkoxysilane based binder and particles such as silica-based or titania based particles. The pretreatment can modify the refractive index by changing the parameters of the pretreatment process using the same sol-gel formulation. The porosity of the resulting porous layer can be controlled by the pretreatment process, including a preheating process or a chemical curing process.

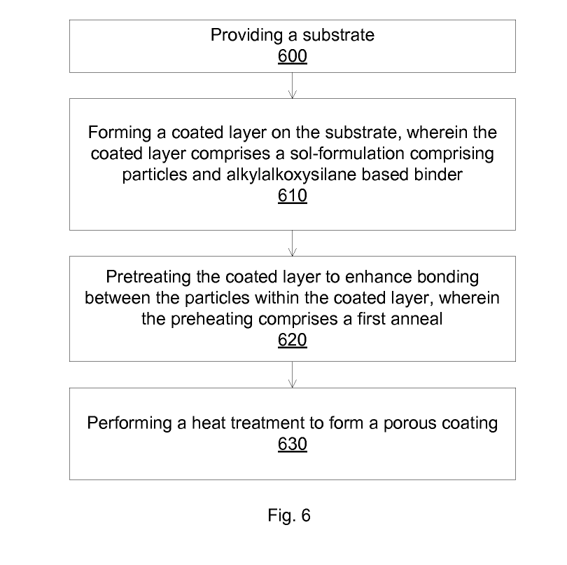

FIG. 6 illustrates a flowchart to process a coating according to some embodiments of the current invention, disclosing a preheating process of a deposited layer to enhance the bonding within the layer before heat treating the layer for forming pores. In operation 600, a substrate is provided. In operation 610, a coated layer is formed on the substrate. The coated layer can include a sol formulation including an alkylalkoxysilane binder and silica-based or titania-based particles. In operation 620, the coated layer is exposed to a preheating process, wherein the preheating can enhance a bonding between the particles within the coated layer. For example, the preheating process can accelerate a condensation reaction, converting silanol groups (Si—OH) of individual particles to interlinked Si—O—Si bonds, coupling the particles. The interlinked bonding can enhance the durability and strength of the porous layer.

In operation 630, a heat treatment is performed to form the porous layer. For example, organic materials within the coated layer can be burned off in a high temperature ambient, leaving pores within an inorganic framework.

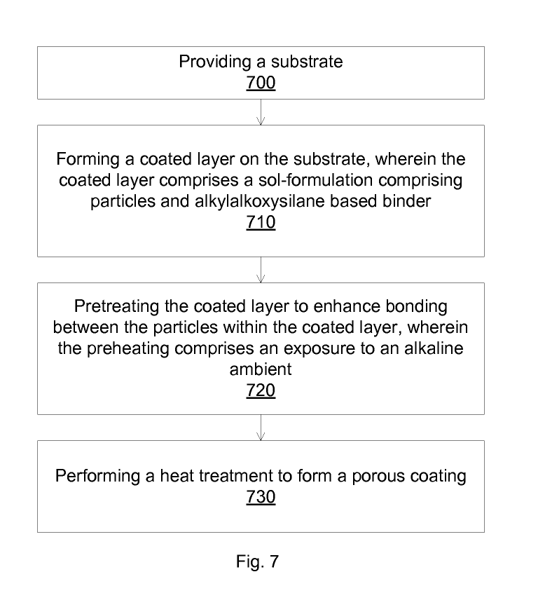

FIG. 7 discloses a method to form a porous layer including silica-based particles according to some embodiments of the current invention, for example, by exposing the coated layer to an ambient including an alkaline vapor, such as ammonia. In operation 700, a substrate is provided. In operation 710, a layer is coated on a substrate. For example, the coated layer can include a sol formulation including an alkylalkoxysilane binder and silica-based particles. In operation 720, the coated layer is pretreated, for example, by exposing to an alkaline vapor, which can strengthen the bonds between the silica-based particles, for example, by accelerating a condensation reaction between the silanol groups. The process can improve the antireflective property, and the durability property of the resulting porous layer. After the exposure, the coated layer can be removed from the alkaline vapor, for example, by evacuating the alkaline vapor or by transferring the substrate to another ambient. Alternatively, the coated layer, or the substrate, can be heat treated, for example, to remove absorbed alkaline vapor.

In some embodiments, the alkaline vapor environment can include alkaline species that condense to a liquid on the particles/coating and can act as a solvent. In some embodiments, the alkaline vapor environment can include ammonia vapor (e.g., alkaline vapor) and OH groups. The OH groups can be present in the vapor. Or the OH groups can be present in adsorbed moisture or alcohol which can already be on the particles/coating. In operation 730, a heat treatment is performed to form the porous layer.

In some embodiments, the current invention discloses a photovoltaic device including a porous antireflective coating formed from the active ambient exposure as described herein. The photovoltaic device includes a porous antireflective coating disposed on a glass substrate. The incoming or incident light from the sun can be first incident on the antireflective coating, passes therethrough and then through the glass substrate before reaching the photovoltaic semiconductor (active film) of the solar cell. The photovoltaic device can also include, but does not require, a reflection enhancement oxide film, and/or a back metallic or otherwise conductive contact and/or reflector. Other types of photovoltaic devices can be used, and the described photovoltaic device is merely illustrative. The antireflective coating can reduce reflections of the incident light and permits more light to reach the thin film semiconductor film of the photovoltaic device thereby permitting the device to act more efficiently.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method of forming a porous coating on a substrate, the method comprising:
forming a coated layer on the substrate, wherein the coated layer comprises an alkylalkoxysilane-based binder and silica based particles;
performing a pretreatment of the coated substrate at a first temperature;
performing a heat treatment of the coated substrate at a second temperature, wherein the heat treatment forms a porous coating.

2. A method as in claim 1 wherein a time of the pretreatment is between 1 second and less than or equal to 5 minutes.

3. A method as in claim 1 wherein a time of the heat treatment is between 1 second and less than or equal to 30 minutes.

4. A method as in claim 1 wherein the first temperature is between 100 C and less than or equal to 400 C.

5. A method as in claim 1 wherein the second temperature is between 300 C and 750 C.

6. A method as in claim 1, wherein the alkylalkoxysilane-based binder comprises a bis(alkoxylsilylalkane) binder.

7. A method as in claim 1 wherein the alkylalkoxysilane-based binder comprises one of n-hexyltriethoxysilane or cyclohexyltrimethoxysilane.

8. A method of forming a porous coating on a substrate, the method comprising:
forming a coated layer on the substrate, wherein the coated layer comprises an alkylalkoxysilane-based binder and silica based particles;
exposing the coated layer to an alkaline ambient;
heat treating the coated substrate, wherein the heat treatment forms a porous coating.

9. A method as in claim 8 wherein the alkaline ambient comprises ammonia.

10. A method as in claim 8 wherein a time of the exposure is between 1 second and less than equal to 5 minutes.

11. A method as in claim 8 wherein a temperature of the exposure is at room temperature.

12. A method as in claim 8 wherein a temperature of the exposure is between 100 C and less than equal to 200 C.

13. A method as in claim 8 wherein a temperature of the exposure is between 100 C and less than equal to 400 C.

14. A method as in claim 8 wherein the time of the heat treatment is between 1 second and less than equal to 30 minutes.

15. A method as in claim 8 wherein the temperature of the heat treatment is between 300 C and 750 C.

16. A coated article comprising:
a substrate;
a coated layer over the substrate, wherein the coated layer is formed by a method comprising:
forming a coated layer on the substrate, wherein the coated layer comprises an alkylalkoxysilane-based binder and silica based particles;
performing a pretreatment of the coated layer;
performing a heat treatment of the coated layer at a second temperature, wherein the heat treatment forms a porous coating.

17. An article as in claim 16 wherein the alkylalkoxysilane-based binder comprises a bis(alkylalkoxysilane)-based binder.

18. An article as in claim 16 wherein the alkylalkoxysilane-based binder is selected from the group consisting of n-propyltriethoxysilane, n-pentyltriethoxysilane, n-hexyltriethoxysilane, cyclohexyltrimethoxysilane, and combinations thereof.

19. An article as in claim 16 wherein the coated layer further comprises an alcohol containing solvent and an acid or base containing catalyst.

20. An article as in claim 16 wherein the pretreatment comprises a thermal treatment at a first temperature or an exposure to an alkaline ambient
